(19) United States
(12) Patent Application Publication
(10) Pub. No.: US 2010/0145755 A1
(43) Pub. Date: Jun. 10, 2010

(54) ARRANGEMENT AND A RELATED METHOD FOR PROVIDING BUSINESS ASSURANCE IN COMMUNICATION NETWORKS

(75) Inventor: Kimmo Narkilahti, Helsinki (FI)

Correspondence Address: WOOD, PHILLIPS, KATZ, CLARK & MORTIMER, 500 W. MADISON STREET, SUITE 3800, CHICAGO, IL, 60661, US

(73) Assignee: AITO TECHNOLOGIES OY, Helsinki (FI)

(21) Appl. No.: 12/452,207

(22) PCT Filed: Jun. 19, 2007
(86) PCT No.: PCT/FI2007/000173

§ 371 Date: Feb. 12, 2010

(51) Int. Cl. G06Q 10/00; G06Q 50/00; G06F 15/173; G06F 11/07

(52) U.S. Cl. 705/8; 705/301; 705/10; 709/224; 714/4; 714/E11.023

(57) ABSTRACT

A business-oriented system and a method for controlling a communications network where: a) network traffic is analysed in order to obtain data about service quality and possible error sources, b) the network functioning and service quality is analysed based on a business model of an operator of the network in order to obtain associated, business-related data effecting at least one factor, such as the operators revenue, churn, sales or marketing, and c) the functioning of the network is optimized by providing a technical correction based on data gathered in steps a) and h) on the basis of predetermined optimization criteria so as to change an operational architecture of the network by said technical correction in order to maximize the operator's revenue, when the operational architecture of the network is changed by said technical correction.

### FIELD OF THE INVENTION

Generally the invention pertains to communication networks. Particularly the invention concerns business-driven network management solutions in the communication networks, such as a mobile network.

### BACKGROUND OF THE INVENTION

Traditionally network operators have separated business management and technical network management from each other by relying on specialized systems for managing both. Accordingly, present technical management aids have been designed to analyze network performance solely in view of technical aspects.

E.g. key performance indicators (KPI) are used to map business-wise important objectives into technically measurable parameters. However, KPIs are typically calculated for a predetermined period concerning multiple events, after which the averaged results are compared with predetermined target values so as to evaluate the performance of the associated activities, which means that a plurality of (business-wise) sub-optimum events may still take place in the network without triggering corrective actions, notwithstanding the KPI based network performance management, as KPIs merely concentrate on network performance on average.

The aforesaid factors easily result in a scenario wherein network management systems, i.e. ‘operations support systems’ (OSS), are not effectively, if at all, coupled to ‘business support systems’ (BSS) and vice versa. Such exemplary scenario is depicted in FIG. 1; customers 102 and supporting processes 104 such as billing/service registration belong to the BSS whereas network/technical resources 106 like various elements and technology management 108 (configuration, fault detection/correction, etc) are included in the OSS. When the coupling between business and technology management, as depicted by the dotted line, is either non-existent or loose, services may be offered and management decisions be made based on faulty or obsolete data. Further, there will be no time to duly react on events effecting costs and revenue. Yet, service rates and various investments in the network infrastructure, ISP-contracts, personnel, and marketing may be selected or at least timed inaccurately, thus also finally resulting in evident revenue loss.

One widely adopted network management model wherein a single network management task have been split into multiple functions has been created by ITU-T for telecommunication networks and is called a Telecommunication Management Network (TMN) model including business, service, network, and element management layers. Business management layer is generally about making business out of underlying services. Service management is about managing network's services on higher level than network management layer does. Example tasks are service level management or actual service provisioning, for example. Network management incorporates configuration management, fault management, is performance management, etc. Element management concentrates on individual network elements and their performance. This model and various other models have a number of common goals: to improve provided services, reduce associated costs (running costs/user fees), and make profit to the operators. How these goals are met, is a more demanding task.

Sometimes technical, qualitative parameters such as accessibility or reliability of network infra are considered to have a certain indirect business impact, so the whole network management is practically based on technical optimization, which is then supposed to cultivate the business as well. This approach is thus technically-oriented and a situation more or less congruent with the one of FIG. 1 is obtained as a result thereof. Information available in the BSS and OSS is not exchanged widely for truly comprehensive network management, which causes one or more of the aforementioned drawbacks.

### SUMMARY OF THE INVENTION

The objective is to alleviate the aforesaid defects of prior art business and network management systems. Such goal is met by provision of an arrangement and a related method for communications network business assurance utilizing available technical means.

One aspect of the present invention provides a method controlling a communications network, the method comprising steps of:
a) analysing network traffic in order to obtain data about service quality and possible error sources,
b) analysing the network functioning and service quality based on a business model of an operator of the network in order to obtain associated, business-related data effecting at least one factor selected from the group consisting of: the operators revenue, churn, sales, cost, and marketing tasks, such as service offering or tariffing, business management such as investment decisions, business intelligence such as customer segmentation or service usage patterns, and
c) optimizing the functioning of the network by providing a technical correction based on data gathered in steps a) and b) on the basis of is predetermined optimization criteria so as to change an operational architecture of the network by said technical correction in order to maximize the operator's revenue, when the operational architecture of the network is changed by said technical correction.

In the aforesaid solution the term ‘user actions’ may refer to communications' services such as voice calls, short messages, data services, WAP/HTTP usage, multimedia messages, mobile-TV exploitation, and video calls, for example.

The term ‘service quality’ refers to quality indicators as defined by predetermined rules and calculated on the basis of network traffic analysis concerning e.g. service accessibility, reliability, transfer delay, RTT (Round Trip Time), transfer rate, etc.

The term ‘communications network’ may refer to a mobile network such as a GSM or UMTS network, fixed network (e.g. the Internet), or aggregate/hybrid networks.

The term “an operational architecture” refers preferably to an operational configuration of the network such as programmatic configurations of network elements so that they are functioning properly and they are able to communicate with each other, as well as also hardware configuration so that the network comprises proper hardware elements in order to make data communication possible in the network via different network elements.

The predetermined optimization criteria may refer to a criteria or threshold which should be passed before any optimization is planned or implemented meaning that any defects with minor business impact can be ignored.

In another aspect of the invention, an arrangement or assurance module for controlling a communications network, where the assurance module is adapted to
a) analyse network traffic in order to obtain data about service quality and possible error sources,
b) analyse the network functioning and service quality based on a business model of an operator of the network in order to obtain associated, business-related data effecting at least one factor selected from the group consisting of: the operators revenue, churn, sales, cost, and marketing tasks, such as service offering or tariffing, business management such as investment decisions, business is intelligence such as customer segmentation or service usage patterns, and
c) optimize the functioning of the network by providing a technical correction based on data gathered in steps a) and b) on the basis of predetermined optimization criteria so as to change an operational architecture of the network by said technical correction in order to maximize the operator's revenue, when the operational architecture of the network is changed by said technical correction.

The means listed above may include e.g. data transfer means for receiving and transmitting data, memory means for storing instructions and data, and processing means for processing instructions and data. The means may incorporate software, hardware, or both.

Determination of network status including traffic information analysis is preferably performed on event basis so that each occurred event may really effect the decision-making. Information about individual events may be gained via monitoring signalling messages, for example.

The utility of the invention arises from a plurality of issues. Firstly, as a result of the disclosed procedures, information controlling both the operator's business operations and the technical management of the network is obtained. Technically oriented business information relating to business indicators, demand, investment decisions, etc may be provided to business management systems to enhance business intelligence. Likewise, technical network management entities can be supplied with business-wise oriented control information including e.g. configuration parameters, prioritization rules, network element utilization rate data, etc. Following the principles of the invention the operator's business can be optimized both directly and undirectly, as major effort in network optimization is now focused on factors having an effect in sales. Further, as optimization measures are concentrated on business-wise remarkable network aspects, the teachings of network management models such as the TMN are cultivated by adding specific two-way connections between various layers for information exchange. When business goals control the network functionalities, not the other way round, the network also performs well, with a high likelihood, from the standpoint of heavy and/or top priority users.

In an embodiment of the invention, a business assurance arrangement is provided for controlling a mobile network. A number of events are monitored and analyzed on technical and business basis. The network is then controlled according to the analysis results.

### BRIEF DESCRIPTION OF THE RELATED DRAWINGS

Below, the embodiments of the invention are described in more detail with reference to the attached drawings in which:

FIG. 1 illustrates prior art network management procedures,

FIG. 2 illustrates one exemplar arrangement for controlling a communications network according to an advantageous embodiment of the invention,

FIG. 3 illustrates an exemplary method for determining a status of and controlling a communications network according to an advantageous embodiment of the invention,

FIG. 4 illustrates an exemplary method for determining possibly lost revenue in a communications network for a certain user service usage attempt according to an advantageous embodiment of the invention,

FIG. 5 illustrates an exemplary method for determining possibly lost revenue in a communications network for a certain user group, session and/or service according to an advantageous embodiment of the invention,

FIG. 6a illustrates an exemplary method for analysing successful sessions in a communications network according to an advantageous embodiment of the invention,

FIG. 6b illustrates an exemplary method for estimating unsuccessful sessions in a communications network according to an advantageous embodiment of the invention,

FIG. 7 illustrates an exemplary method for determining revenue and possibly lost revenue in a communications network according to an advantageous embodiment of the invention,

FIG. 8 illustrates an exemplary chart 800 for dividing subscribers to service groups and information usable for calculating the revenue and possibly lost revenue in a communications network according to an advantageous embodiment of the invention,

FIGS. 9a-h illustrate an exemplary software application through number of lay outs, where the software implementation implements the method steps depicted in FIGS. 3-7 in a communications network according to an advantageous embodiment of the invention,

FIG. 10 illustrates an exemplary assurance module for controlling a communications network based on a business model according to an advantageous embodiment of the invention, and

FIG. 11 illustrates an exemplary computer program product for controlling a communications network based on a business model according to an advantageous embodiment of the invention

### DETAILED DESCRIPTION OF THE EMBODIMENTS

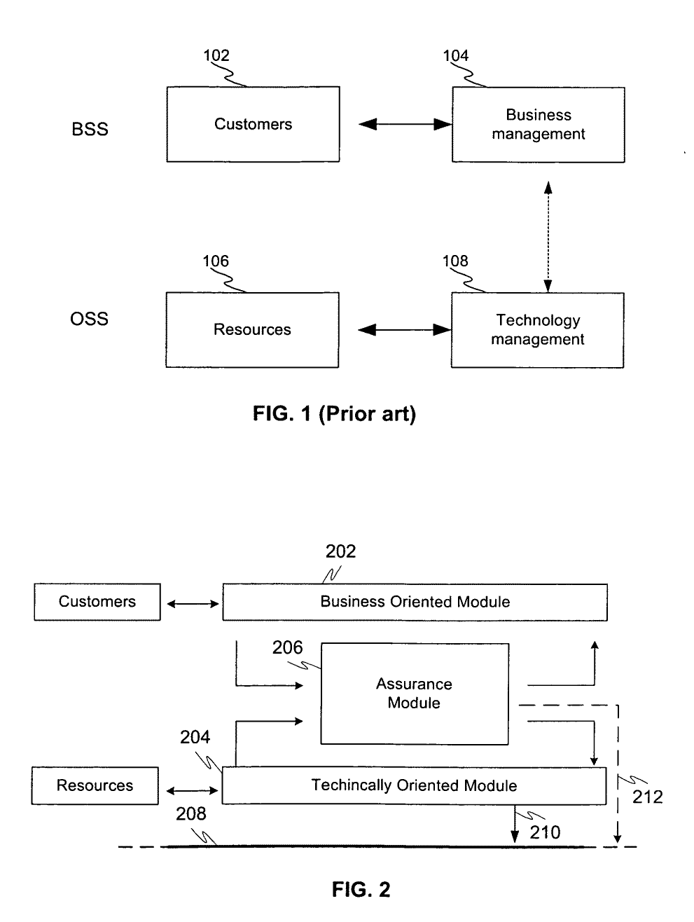

FIG. 1 visualizes prior art as described above.

FIG. 2 illustrates one exemplary arrangement 200 of the invention for controlling a communications network 208, where a technology oriented module 202 is used for analyzing a network status and user actions via number of network indicators (such as network traffic or user transactions) from the network elements, such as from the SGSN, GSN, GGSN, Media Gateways, MSC, Call Processing Servers, Traffic analyzer probes, etc. in order to get data of service quality and possible error sources. The user action may be for example voice call, SMS, data services, WAP/http, MMS, mobile-TV, or video call. The service quality may depend for example on traffic or load, capacity, errors, service usage, delays, response time, transfer rate, administrative errors, user errors, availability or reliability of service.

In addition a business oriented module 204 is used for analyzing, based on business model of an operator of the network 208, the network status, as well as also quality recognized by the end user in order to obtain business related data effecting to the operators revenue, where the network status relates to traffic or load, errors, service usage, delays, response time, transfer rate, availability and reliability of service. An assurance module 206 is adapted to optimize the network based on data gathered by the technology and business oriented modules on the basis of predetermined optimization criteria so as to maximize the operator's revenue. The optimization is advantageously based on individual events, and may relate to optimizing configurations of a network element or even proposing to change the element to a new one, for example. Sometimes the optimization can be realized by programmatically, but sometimes the optimization may require actions by the operator, for example if the error to be corrected is very complex or correction requires to install new hardware, for example.

According to an embodiment of the invention the assurance module 206 is adapted to gather technically related data from the technology oriented module 202 and technically oriented business information from the business oriented module 204, and based on this data to form control data by which the network can be optimized. In one embodiment the assurance module 206 is adapted to output a constant feedback of technically driven business management data to the business oriented module 204 of the operator, as well as to output a constant feedback of business driven technical management data to the technology oriented module 202 of the operator.

Both the technology oriented module 202 and the business oriented module 204 may be adapted to modify technically related data and technically oriented business information, respectively, based on the feedback output by the assurance module 206. Examples of such cases are: modification of network's operational configuration to optimize profitability (technical) or changes in the service pricing model or charging tariffs (business) to increase revenue. Or alternatively a suitable example required—a low-performance handset can be pinpointed in high value customer segment resulting in twofold action: 1. technical systems can be prompted to provision new settings for this segment customers with this particular handset model with older software settings, and 2. Business and Product Management can be alerted of low-performing handset for their target segment and take corrective action in product offering and packaging.

The constant feedback of technically driven business management data may be for example business indicator, demand, or investment, whereas the constant feedback of business driven technical management may be for example configuration parameter, or prioritization rule. The assurance module 206 is typically adapted to analyse the network status by gathering traffic data from network controlling means, such as MSC and SGSN, and service providing means, such as WAP gateway, WEB server or MMSC.

Furthermore the assurance module 206 is adapted to analyse the effect of the network traffic to the operator's revenue by comparing the traffic information of the network traffic to charging information from the Customer Relationship Management (CRM) in order to get statistic information about the typical revenue of the network. The assurance module 206 may also be adapted to analyse the effect of the change in the service quality of individual subscriber to the operator's revenue by comparing the service quality to charging information. Additionally, according to an exemplary embodiment, the assurance module 206 may be adapted to analyse the effect of the errors in the network to the operator's revenue by comparing the current revenue of the broken down network element to typical revenue of said network element.

However, there may also be other means to calculate the lost revenue in the network than comparison to that particular network element's revenue trend. The lost revenue can be calculated also for each unsuccessful service usage attempt by combining subscriber's charging information to service usage information and statistical methods. Each unsuccessful event has also a root cause, which can be localized to a single network element when needed.

The assurance module 206 may also be adapted to analyse the usage information of services in the network and use it for determing demand, marketing and sales analysis, utilization rate of the network element, and to make investment decisions for example.

When the optimization is realized by programmatically, it can be implemented for example by technically oriented module 204 via line 210 at least partly based on said feedback data output by the assurance module 206. However, in an exemplary embodiment the optimization can be implemented also by the assurance module 206 via line 212 based on said data gathered from the technically oriented module 204 and/or business oriented module 202.

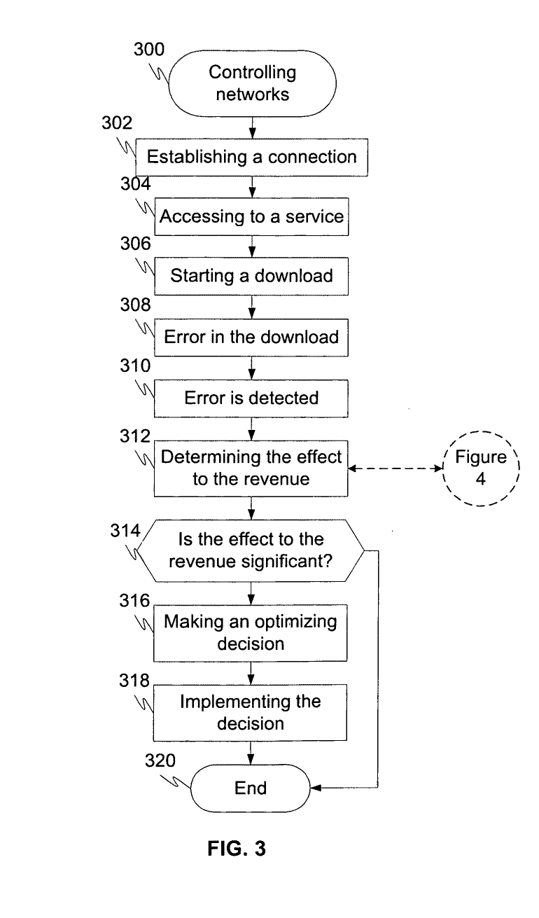

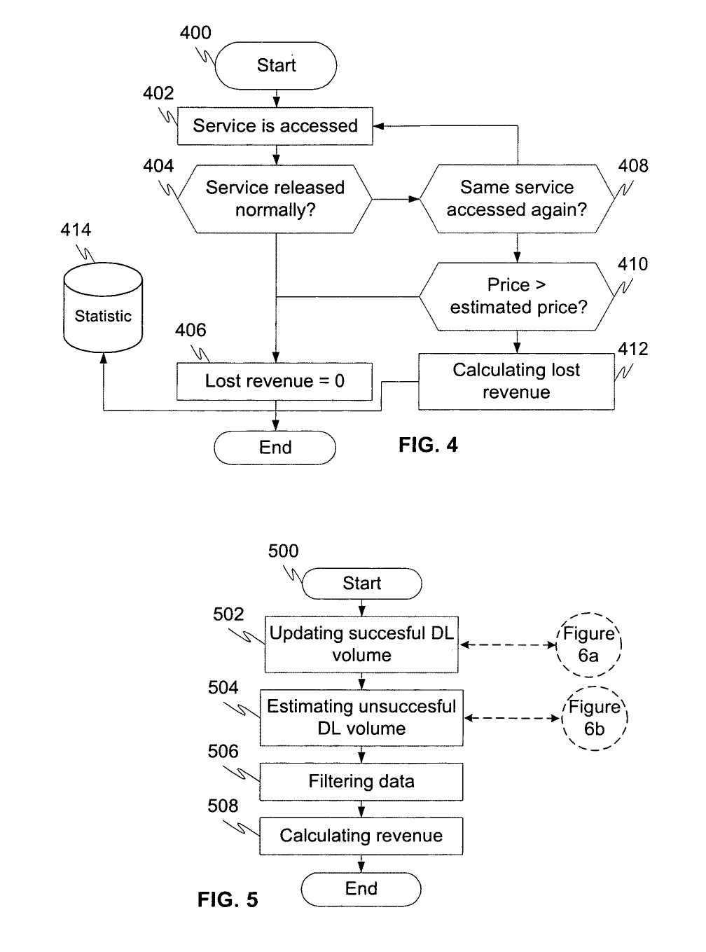

FIG. 3 illustrates an exemplary method 300 for determining a status of and controlling a communications network generally, when an error occurs. The method 300 (such as also methods described in FIGS. 4, 5, 6a, and 6b) applies especially to services such as WAP, HTTP, but not for example to voice or SMS since there's no download involved.

At step 302 a connection is established, for example when a user would like to download a file from a server using a GPRS connection. When the connection is established the user may be accessed at step 304 to a service, such as a music downloading service in order to download MP3 files. After finding an interesting piece the downloading is started at step 306.

However, if there appears some error in the downloading 308, it is detected in step 310 for example by analysing the reliability of the service or having an error code from a network element, such as from SGSN, and a root of the error is determined and localized for example by comparing traffic data of the network with configuration data of the network or by comparing the root of the error to hierarchy of the network and to other coincident quality changes in the network. The root of the error may be for example wrong configurations in the user's terminal.

According to an embodiment of the invention a threshold for reliability of the service can be set so, that for example if the reliability is less than 95% for high-revenue customers, for example, root of the error is analysed in more details. The reliability means unsuccessful transactions during a session compared to successful transactions.

When an error is detected its effect to revenue of an operator is analysed in step 312. More detailed method for analysing possibly lost revenue is illustrated in connection with FIG. 4. In step 314 effect of the revenue or lost revenue is analysed whether it is significant or not. If the effect is not significant, the current session analysis is stopped, otherwise an optimizing decision for network is made in step 316, such as provisioning new configurations to a terminal type of the user's terminal. In order to detect the business impact the amount of the estimated lost revenue is compared to a threshold parameter y set beforehand, which can be changed for example by an operator. If the lost revenue is greater than the threshold parameter y, further action is performed, such as provisioning new configurations. An appropriate further action, if needed, is selected by combining error codes and information about network elements, and analysing and comparing them with information of a database about the error codes in order to detect how the errors or problems can be corrected and thus the network optimized. The database may advantageously comprise information relating to correction actions, where the information is arranged to be detected based on the error codes.

In step 318 the optimizing decision is implemented, such as new configurations are provided to the user's terminal, or possibly even all terminals of same, type as the user's terminal. The implementation can be done automatically especially if an error and solution or correction is straightforward. By the method 300 technical drawbacks, technical barriers and root of errors and other technical weakness in the network incurring loss of revenue can be detected and localised, and their effect to revenue can be estimated, as well as also correction operations or network optimizing operation and implementation can be provided. Thereby the technically optimized communications network can be achieved and customer satisfaction can be improved. The steps 302-308 are related very closely to the customer, whereas the steps 310-316 are managed by the present invention and the step 318 the operator.

The step 318 can be also implemented by the invention in the case correction is pre-approved by the operator (e.g. New parameters to the handset).

FIG. 4 illustrates an exemplary method 400 for estimating lost revenue in a communications network in connection with a certain user, user group or service usage attempt when the service is accessed in step 402. In step 404 it is determined from SGSN (Serving GPRS Support Node) for example whether the service is released normally, or is there any error. If the service is released normally, lost revenue is analysed to be zero (step 406). However, if there occurs an error and the service is not released normally, it is determined in step 408 whether the same service is accessed again by the same terminal (or user) possibly within a certain time window. If yes, the process is continued again in step 402, but if the service is not accessed again the estimation of possible lost revenue is made in step 410.

In simplest the estimation in step 410 can be made by comparing the price already got from the interrupted service with the estimated price of the service. The price got from the interrupted service can be estimated by comparing volume downloaded by the subscriber before interruption and average price for the subscriber's billing group in the service, to which the subscribers are divided according to operator's billing scenario, for example. The average price of the subscriber's billing group depends strongly on age of the subscriber, time of day, and used terminal type (2G/3G e.g.), for example. The estimated price of the service can be estimated by average price per service attempt for said ARPU (Average Revenue Per User) group.

The subscribers can be divided to the billing groups according to the operator's billing scenario, such as Pre-paid and Post-paid groups, where Post-paid group may include 1) Package pricing, where price of package contains certain capacity, such as 10∈=100 MMS; 2) Ad-hoc pricing, where fee is starting fee+volume*price per capacity unit, for example; 3) Flat-fee, where the fee=price of fee/average service usage per flat-fee user; and 4) Time-based sub-groups, for example starting fee per hour. In addition the subscribers can be divided to the service groups according to the operator's service scenario, as is illustrated in connection with FIG. 8.

If the price already got from the interrupted service is less than the estimated price of the service, the lost revenue is estimated in step 412 for example by subtracting the price of service attempt from the average service price. An example of more detailed method for analysing revenue or possibly lost revenue is illustrated in connection with FIG. 5. Otherwise lost revenue is zero.

In final step of method 400 statistic data of the analysis and estimation is advantageously stored to a database 414 and the process is ended. Statistic data may be for example download volume data of each successful transaction during the session, terminal type, ARPU and time of day. This information will be used for determing average prices as described in 412.

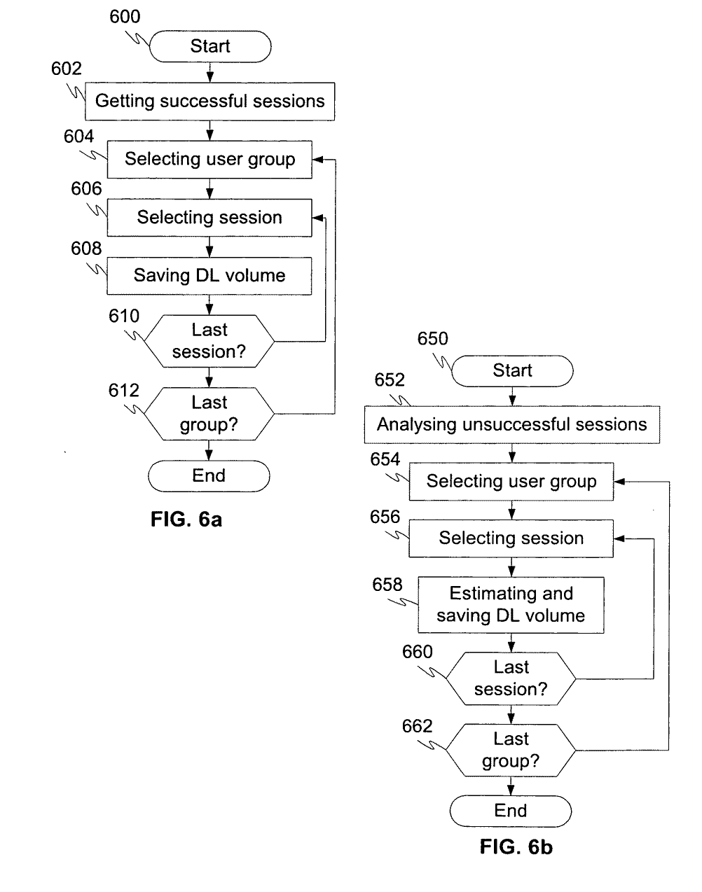

FIG. 5 illustrates an exemplary method 500 for determining revenue and/or possibly lost revenue in a communications network for a certain user group, session and/or service. The method 500 consists of number of steps, where in step 502 downloaded volumes of successful sessions are updated to a database (see more detailed description in connection with FIG. 6a) and in step 504 downloaded volumes of successful sessions are estimated and updated to the database (see more detailed description in connection with FIG. 6b). In step 506 unsuccessful sessions that are successfully accessed within given time window are filtered out. The appropriate time window can be adjusted for each sessions or services, or even user group. In step 508 revenue or lost revenue is calculated as depicted in connection with step 412.

FIG. 6a illustrates an exemplary method 600 for analysing successful sessions and download volumes relating to these sessions in a communications network advantageously for each user groups and sessions from that group. Data of all successful sessions can be got from the database 414 in step 602, for example, or straight gathered from the SGSN, for example. A group for which the analysis is performed is selected in step 604 and session from the selected group is selected in step 606, respectively, after which download volume data relating to said session is saved to a database in step 608. In step 610 it is determined whether the session was last one. If not, the next session is selected from the group in step 606, if yes, the next user group is selected in step 604 if the group was not the last one (step 612). However, if the user group was last one, process is ended, after which the updated database contains data of successful sessions, such as successfully downloaded volumes per user group, session, service, terminal type, time of day, and ARPU, for example.

FIG. 6b illustrates an exemplary method 650 for analysing unsuccessful sessions and estimating download volumes relating to these sessions in a communications network advantageously. Data of all unsuccessful sessions can be got from the database 414 in step 652, for example, or straight gathered from the SGSN, for example. A group for which the estimation is performed is selected in step 654 and session from the selected group is selected in step 656, respectively. However it should be noted that estimation can be done separately for each individual event, and running the estimation in two nested loops (groups and users) is not necessarily needed.

In step 658 estimated download volume (i.e. downloaded volume and volume which could has been downloaded after interruption) relating to said session is estimated. The estimation can be figured out from average download volumes of the subscriber's group in the service. The average downloaded volume of the subscriber's group depends strongly on age of the subscriber, time of day, and used terminal type (2G/2G e.g.), for example, and quite often very accurate estimate can be made from these data in order to estimate the volume which the subscriber would has been downloaded if the session was successful. Data about estimated download volume is saved to a database also in step 658.

In step 660 it is determined whether the session was last one. If not, the next session is selected from the group in step 656, if yes, the next user group is selected in step 654 if the group was not the last one (step 662).

However, if the user group was last one, process is ended, after which the updated database contains data of successful sessions, such as successfully downloaded volumes per user group, session, service, terminal type, time of day, and ARPU, for example.

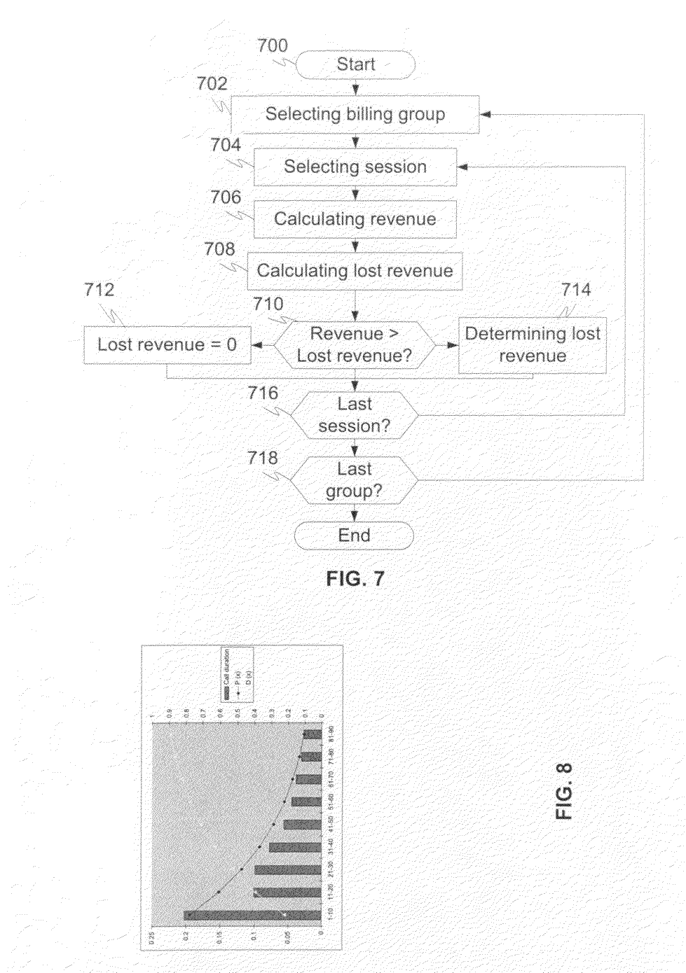

FIG. 7 illustrates an exemplary method 700 for analysing revenue and possibly lost revenue in a communications network for each user groups and sessions from that group, where a billing group is selected in step 702 and session in step 704, for which the analysis is performed. In step 706 revenue is calculated based on the current billing group and downloaded volume, whereas lost revenue is estimated in step 708 based on the current billing group and estimated download volume.

In step 710 it is estimated whether realized revenue is at least as much than estimated lost revenue. If yes, then lost revenue is marked as zero (step 712), but if not, lost revenue is estimated to be the difference of estimated lost revenue and realized revenue (step 714).

In step 716 it is determined whether the session was last one. If not, the next session is selected from the group in step 704, if yes, the next billing group is selected in step 702 if the group was not the last one (step 718). However, if the billing group was last one, process is ended, after which the total lost revenue for an operator, for example, is determined.

FIG. 8 illustrates an exemplary chart 800 for dividing subscribers to service groups (an example of the possible groups) and information usable for calculating the revenue and possibly lost revenue in a communications network, where the subscribers are divided to the service groups that correlates best to the service usage pattern as can be seen from the chart and table 800, where about 20% of the subscribers belongs to the service group, where a typical call length is 1-10 sec, about 10% belongs to the service group, where a typical call lengths is 11-20 sec, etc. Transactions are kept track on separately for each correlation group. Call lengths (or data volumes) can be calculated from the statistic for each ARPU group separately exploiting a finding that call lengths are distributed exponentially as:

P(x)=λe^{-λx},

whereupon a cumulative distribution function is:

D(x)=1−e^{-λx}.

User transactions have been grouped according to their duration (0-10, 10-20 etc) and bars present the count of transactions in each duration group. The calculation is the probability distribution for exponentially distributed data (such as call durations). D(x) implies the probability of the duration of the next session being equal or smaller than the respective duration group. Based on the grouping the operator can also find, for example, that the next call (during Monday, hour 9 for an ARPU group 1) is going to be shorter than 30 seconds with the probability of 52.8%. This information can be used for calculating the revenue for certain user in certain billing group with certain probability.

Also successful calls or session can be selected based on clear codes and noted that probably over 95% of all session are successful. In addition the revenue calculation for each session can be made based on download volume and user billing group, for example, or calculation for voice calls on call duration and billing group. Some billing groups for some services might require information about session duration, thus session durations should be saved similarly to a database as download volumes or call durations.

Statistics, such as session durations and download volumes, are advantageously stored to a database for each kind of user groups based on ARPU, time of the day, handset type (2G/3G) or user age, for example. In an exemplary embodiment of the invention there can be 6 ARPU groups, 4 time groups, 2 handset groups and 6 age groups, for example, whereupon total number of the user groups are 288. The user groups should be defined in an own table, so that those can be changed easily. In an exemplary embodiment each row for different user group and each column contain number of sessions for different download volumes. Also date is saved to the table thus it is possible to have daily distributions for x days (e.g. 7) and then longer average can be saved e.g. for weekly or monthly basis.

Thus also unsuccessful calls or session can be selected based on clear codes (SQL) and noted that probably less than 5% of all session are unsuccessful, whereupon the lost revenue estimation for each session can be estimated by fetching estimated download volume for this kind of users group, for example.

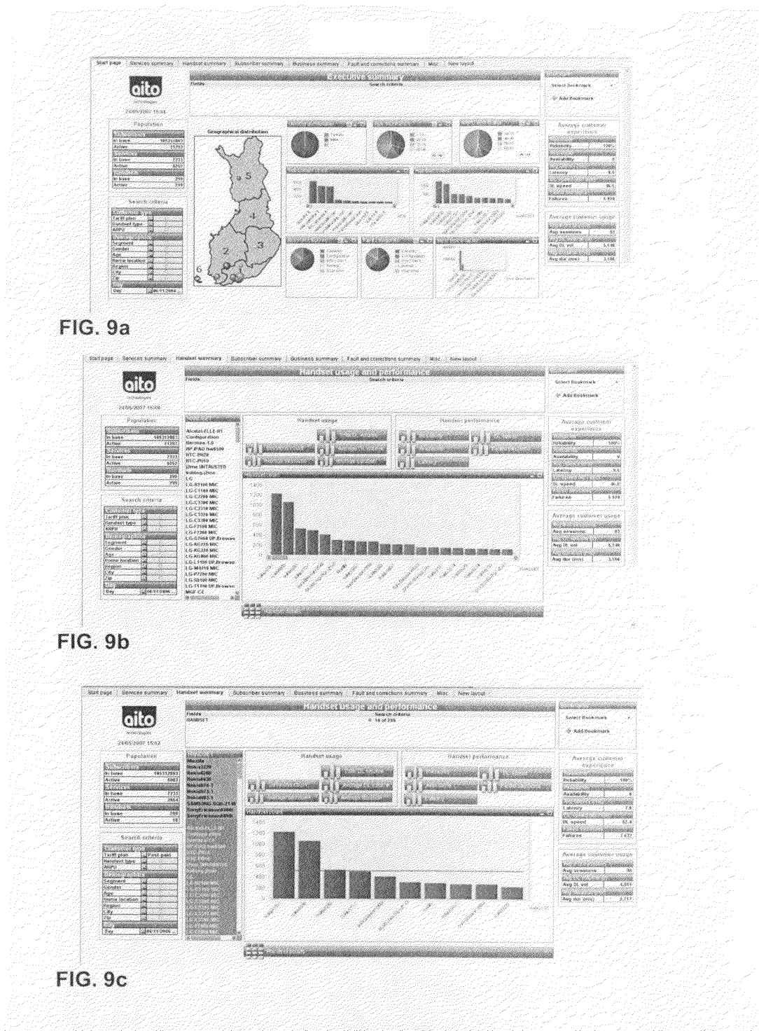

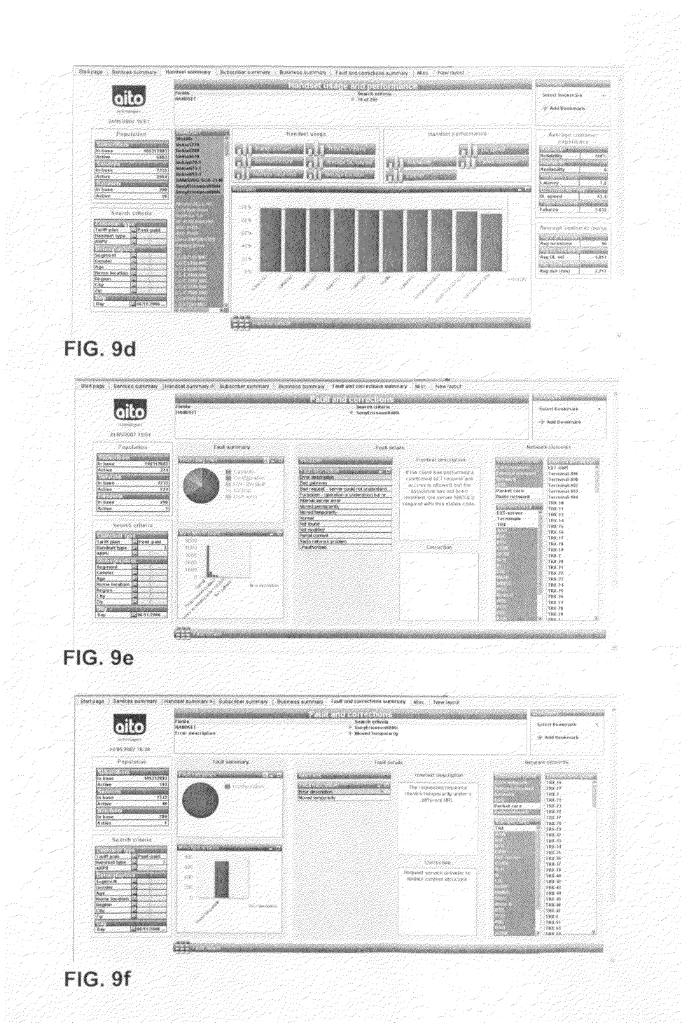

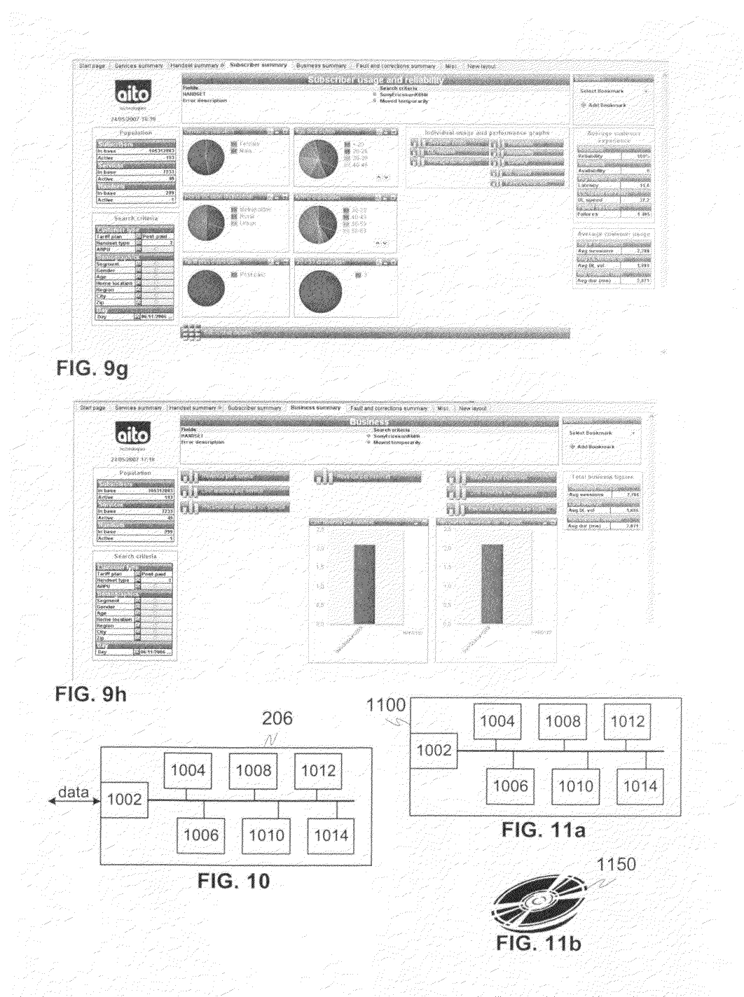

FIGS. 9a-h illustrate an exemplary software application and an exemplary analysis of the network through number of lay outs, where the software implementation implements the method steps depicted in FIGS. 3-7 in a communications network, where FIG. 9a illustrates a main view of the program offering total view to features analysed by the method of the invention, such as demographic information about subscribers (gender, age, ARPU, home location, region, city), average customer experience (reliability, availability, average latency, download speed and failed session), average customer usage (sessions, download volume, average duration), as well as technical information about the network such as fault categories or most typical faults with error description. In FIG. 9a the operator is interested about reliability and selects handset summary, whereupon a view of handset usage and performance is shown to the operator, as depicted in FIG. 9b.

In the example the operator is interested all top 10 handsets, whereupon (s)he selects said handsets after which all information in the application is updated respectively, as can be seen from FIG. 9c when comparing for example average customer experiences and usages in FIGS. 9b and 9c. In FIG. 9c the operator selects reliability report in order to find out the reliability of said top 10 handsets, whereupon a view of the reliability report is shown as depicted in FIG. 9d.

It can be seen from the reliability report (FIG. 9d) that reliability of one handset type is worse than others, whereupon said handset type can be selected, and faults and correction report is shown, as is depicted in FIG. 9e, in order to find out factors behind the decreased reliability. As it can be seen from FIG. 9e problems culminate with one factor (longest bar in the Most typical faults diagram), which can be selected in order to see the factor in more detail, as depicted in FIG. 9f. The application of the invention is advantageously adapted to determine correction action based on error codes and information about network elements, and analyse and compare them with information of a database about the error codes, whereupon the operator can see the definition of the error and detect the network element to which the error relates. In addition correction action is proposed by the application, where the correction action can be implemented by the application automatically without any user action, or alternatively the correction action can be instruction, such as an advice to request a service provider to update content structure.

The application is also adapted to determine a special target group to which the drawback relates, which can be reviewed by selecting a subscriber summary as is depicted in FIG. 9g, where it can be seen that the drawback effects especially subscribers under age 20 years, who has quite high ARPU and lives in city. In addition the application is adapted to determine a criticality of the drawback also in view of business, which can be viewed by selecting a business summary in the program (see FIG. 9h) telling that the application is also adapted to determine a business impact of said drawback as a revenue or lost revenue, as well as also recoverable revenue meaning that how much of the drawback can be corrected programmatically, such as provisioning new terminal configurations to said handset type having problem with this service.

FIG. 10 illustrates an assurance module 206 in more details for controlling a communications network 208, such as a mobile network, where the assurance module 206 is adapted to monitor a number of events and analyze on technical and business basis, and where the network is then controlled according to the analysis results either directly by the assurance module or via an other module, such as a technically oriented module.

The assurance module 206 advantageously comprises e.g. data transfer means 1002 for receiving and transmitting data (interfacing with the technically oriented module, business oriented module and/or directly with the network), memory means 1004 for storing instructions and data, and data processing means 1006 for processing instructions and data. The means may incorporate software, hardware, or both. The data transfer means may be adapted to be in connection with a network management and other controlling elements, such as MSC and SGSN and service providing means, such as WAP gateway, WEB server and MMSC, so that the data transfer means is able to gather data about traffic or load in the network, errors, service usage, delays, response time, transfer rate, as well as availability and reliability of a service, such as whether the service is released normally or not, and was the session successful or unsuccessful. In addition the assurance module 206 comprises a data bus 1001 connecting different means of the assurance module 2006 so that they are able to communicate with each other via said data bus.

The data transfer means is also adapted to gather technically related data from the technology oriented module 202 (depicted in FIG. 2) and technically oriented business information from the business oriented module 204 (depicted in FIG. 2), whereupon a controlling means 1008 is adapted to form, based on data from technology and business oriented modules, control data by which the network can be optimized.

In one embodiment the assurance module 206 comprises feedback means 1010 adapted to output a constant feedback of technically driven business management data to the business oriented module of the operator so that the business oriented module can take into account the technical state of the network, as well as to output a constant feedback of business driven technical management data to the technology oriented module of the operator so that the technically oriented module can take into account the business model of the operator when optimizing the network, such as configuring settings or parameters of the network.

In addition the assurance module 206 comprises also analysis means 1012 to analyse the effect of the network traffic and other network event to the operator's revenue by comparing the traffic information of the network traffic to charging information from a Customer Relationship Management (CRM) in order to get statistic information about the typical subscribers of the network. The analysis means 1012 may also be adapted to analyse the effect of the change in the service quality of individual subscriber to the operator's revenue by comparing the service quality to charging information. Additionally the analysis means 1012 may be adapted to analyse the effect of the errors in the network to the operator's revenue by comparing the current revenue of the broken down network element to typical revenue of said network element. The analysis means 1012 may also be adapted to analyse the usage information of services in the network and use it for determining demand, marketing and sale analysis, utilization rate of the network element, and to make investment decisions for example. The analysis means is advantageously adapted to co-operate with other means of the assurance module, such as the data processing unit 1006 and memory means 1004.

Furthermore the analysis means 1012 can be adapted to detect an error in a downloading for example by analysing reliability of the service or having an error code from a network element, such as from MSC or SGSN, and determine a root of the error and localize it for example by comparing traffic data of the network with configuration data of the network or by comparing the root of the error to hierarchy of the network and to other coincident quality changes in the network.

Very closely with an operational functioning with the analysis means 1012 is arranged decision making means 1014, which is advantageously adapted to make optimizing decisions for optimizing the functioning of the network, such as provisioning new configurations to the network or a terminal type, for example. The analysis means 1012 as well as decision making means 1014 are advantageously adapted to make analysis and decisions, respectively, based on individual events.

FIG. 11 illustrates an exemplary computer program product 1100 for controlling a communications network, where the computer program product 1100 is adapted to monitor a number of events and analyze on technical and business basis, when said computer program product is run on a computer, and where the network is then controlled according to the analysis results either directly by the assurance module or via an other module, such as a technically oriented module.

The computer program product 1100 advantageously comprises e.g.

computer code means 1102 for receiving and transmitting data (interfacing with the technically oriented module, business oriented module and/or directly with the network), and computer code means 1104 for storing instructions and data to a database when said computer program product is run on a computer. The computer code means 1102 is also adapted to gather technically related data from the technology oriented module 202 (depicted in FIG. 2) and technically oriented business information from the business oriented module 204 (depicted in FIG. 2), whereupon computer code means 1108 is adapted to form, based on data from technology and business oriented modules, control data by which the network can be optimized, when said computer program product is run on a computer.

In one embodiment the computer program product 1100 comprises computer code means 1110 adapted to output a constant feedback of technically driven business management data to the business oriented module of the operator so that the business oriented module can take into account the technical state of the network, as well as to output a constant feedback of business driven technical management data to the technology oriented module of the operator so that the technically oriented module can take into account the business model of the operator when optimizing the network, such as configuring settings or parameters of the network, when said computer program product is run on a computer.

In addition computer program product 1100 comprises also computer code means 1112 adapted to analyse the effect of the network traffic and other network event to the operator's revenue by comparing the traffic information of the network traffic to charging information from a Customer Relationship Management (CRM) in order to get statistic information about the typical subscribers of the network, when said computer program product is run on a computer. The computer code means 1112 may also be adapted to analyse the effect of the change in the service quality of individual subscriber to the operator's revenue by comparing the service quality to charging information.

Additionally the computer code means 1112 may be adapted to analyse the effect of the errors in the network to the operator's revenue by comparing the current revenue of the broken down network element to typical revenue of said network element. The computer code means 1112 may also be adapted to analyse the usage information of services in the network and use it for determining demand, marketing and sale analysis, utilization rate of the network element, and to make investment decisions for example, when said computer program product is run on a computer.

Furthermore the computer code means 1112 can be adapted to detect an is error in a downloading for example by analysing reliability of the service or having an error code from a network element, such as from MSC or SGSN, and determine a root of the error and localize it for example by comparing traffic data of the network with configuration data of the network or by comparing the root of the error to hierarchy of the network and to other coincident quality changes in the network, when said computer program product is run on a computer. Still the computer program product 1100 may comprise computer code means 1114, which is advantageously adapted to make optimizing decisions for optimizing the functioning of the network, such as provisioning new configurations to the network or a terminal type, for example, when said computer program product is run on a computer. The computer code means 1112 as well as computer code means 1114 are advantageously adapted to make analysis and decisions, respectively, based on individual events.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

1. Method for controlling a communications network, the method comprising steps of:
a) analysing network traffic in order to obtain data about service quality and possible error sources,
b) analysing the network functioning and service quality based on a business model of an operator of the network in order to obtain associated, business-related data effecting at least one factor selected from the group consisting of: the operators revenue, churn, sales, cost, and marketing tasks, such as service offering or tariffing, business management such as investment decisions, business intelligence such as customer segmentation or service usage patterns, and
c) optimizing the functioning of the network by providing a technical correction based on data gathered in steps a) and b) on the basis of predetermined optimization criteria so as to change an operational architecture of the network by said technical correction in order to maximize the operator's revenue, when the operational architecture of the network is changed by said technical correction.

2. The method according to claim 1, wherein in step a) the possible error sources are localized by combining traffic data of the network with configuration data of the network.

3. The method according to claim 1, wherein in step a) the root of the possible error source is determined by comparing error data of traffic information to error analyses determined beforehand.

4. The method according to claim 1, wherein in step b) also data effecting to lost revenue, churn, sales and/or marketing is determined.

5. The method according to claim 1, wherein in step c) the optimization is based on individual events.

6. The method according to claim 1, wherein in step c) the optimization of the network comprises at least one of the following: assessment of terminal and/or network configuration, service activation, or customer provisioning.

7. The method according to claim 1, wherein a .constant feedback of technically driven business management data is outputted to a business controlling arrangement of the operator so that the technical state of the network can be taken into account when making business oriented decisions.

8. The method according to claim 7, wherein a constant feedback of technically driven business management data is at least one of the following: business indicator, demand, or investment.

9. The method according to claim 1, wherein a constant feedback of business driven technical management data is outputted to a technology controlling arrangement of the operator so that the business model can be taken into account when optimizing the network.

10. The method according to claim 9, wherein a constant feedback of business driven technical management data is at least one of the following: is configuration parameter or prioritization rules of a network element.

11. The method according to claim 1, wherein the network traffic is analysed by gathering traffic data from network controlling means, such as SGSN, GSN, GGSN, Media Gateways, MSC, Call Processing Servers, or Traffic analyzer probes, and service providing means, such as WAP gateway, WEB server and MMSC.

12. The method according to claim 1, wherein in step b) the effect of the behaviour of the end user and network to the business of the operator is determined.

13. The method according to claim 12, wherein b1) the effect of the network traffic to the operator's revenue is determined by comparing the traffic information of the network traffic to charging information from the Customer Relationship Management (CRM) in order to get statistic information about the typical subscribers of the network.

14. The method according to claim 12, wherein b2) the effect of the change in the service quality of individual subscriber to the operator's revenue is determined by comparing the service quality to charging information.

15. The method according to claim 12, wherein b3) the effect of the errors in the network to the operator's revenue is determined by combining subscriber's charging information to service usage information and statistical methods.

16. The method according to claim 12, wherein b4) the usage information of services in the network is determined and used for determining demand, marketing and sales analysis, and to make investment decisions.

17. An assurance module for controlling a communications network, where the assurance module is adapted to a) analyse network traffic indicators in order to obtain data about service quality and possible error sources, b) analyse the network functioning and service quality based on a business model of an operator of the network in order to obtain associated, business-related data effecting at least one factor selected from the group consisting of: the operators revenue, churn, sales, cost, and marketing tasks, such as service offering or tariffing, business management such as investment decisions, business intelligence such as customer segmentation or service usage patterns, and c) optimize the functioning of the network by providing a technical correction based on data gathered in steps a) and b) on the basis of predetermined optimization criteria so as to change an operational architecture of the network by said technical correction in order to maximize the operator's revenue, when the operational architecture of the network is changed by said technical correction.

18. The assurance module according to claim 17, wherein the assurance module is in step a) adapted to localize the possible error sources by combining traffic data of the network with configuration data of the network.

19. The assurance module according to claim 17, wherein the assurance module is in step a) adapted to determine the root of the possible error source by comparing error data of traffic information to error analyses determined beforehand.

20. The assurance module according to claim 17, wherein the assurance module is in step b) adapted also to determine data effecting to lost revenue, churn, sale and/or marketing.

21. The assurance module according to claim 17, wherein the assurance module is in step c) adapted to perform the optimization based on individual events.

22. The assurance module according to claim 17, wherein the assurance module is adapted to output a constant feedback of technically driven business management data to a business controlling arrangement of the operator so that the technical state of the network can be taken into account when making business oriented decisions.

23. The assurance module according to claim 17, wherein the assurance module is adapted to output a constant feedback of business driven technical management data to a technology controlling arrangement of the operator so that the business model can be taken into account when optimizing the network.

24. The assurance module according to claim 17, wherein the assurance module is adapted to determine the network status by gathering traffic data from network controlling means, such as SGSN, GSN, GGSN, Media Gateways, MSC, Call Processing Servers or Traffic analyzer probes, and service providing means, such as WAP gateway, WEB server and MMSC.

25. The assurance module according to claim 17, wherein the assurance module is in step b) adapted to determine the effect of the behaviour of the end user and network to the business of the operator.

26. The assurance module according to claim 25, wherein the assurance module is b1) adapted to determine the effect of the network traffic to the operator's revenue by comparing the traffic information of the network traffic to charging information from the Customer Relationship Management (CRM) in order to get statistic information about the typical revenue of the network.

27. The assurance module according to claim 25, wherein the assurance module is b2) adapted to determine the effect of the change in the service quality of individual subscriber to the operator's revenue by comparing the service quality to charging information.

28. The assurance module according to claim 25, wherein the assurance module is b3) adapted to determine the effect of the errors in the network to the operator's revenue by combining subscriber's charging information to service usage information and statistical methods.

29. The assurance module according to claim 25, wherein the assurance module is b4) adapted to determine the usage information of services in the network and to use it for determining demand, marketing and sale analysis, and to make investment decisions.

30. A computer program product directly loadable into the internal memory of a digital computer, where the computer program product comprises software code portions for performing the steps of claim 1 when said product is run on a computer.

31. A computer program product stored on a computer usable medium, where the computer program product comprises computer readable program means for causing a computer to perform the steps of claim 1 when said product is run on a computer.
